(19) United States
(12) Patent Application Publication
(10) Pub. No.: US 2005/0223621 A1
(43) Pub. Date: Oct. 13, 2005

(54) All-wool fly tying system

(76) Inventor: James J. Merlihan, Darlington, MD (US)

Correspondence Address: Royal W. Craig;Law Offices of Royal W. Craig, Suite 153, 10 N. Calvert Street, Baltimore, MD, 21202, US

(21) Appl. No.: 11/101,002

(22) Filed: Apr. 7, 2005

Related U.S. Application Data
(60) Provisional application No. 60/560,325, filed on Apr. 7, 2004.

(51) Int. Cl. A01K 85/08

(52) U.S. Cl. 43/42.53; 43/42.25

(57) ABSTRACT

A method of tying a fly using wool as the primary material, comprising the steps of obtaining a palette of different wool staples varying in species of sheep, processed form and coloration, extracting tufts of wool from selected staples, twisting said tufts between the thumb and index finger of each hand to create twisted tuft yarns, positioning one of said twisted yarns along a hook (leaving space for a collar and fly head), and creating a post on the hook by tying the twisted tuft yarn to the hook with thread, ensuring that the fibers of yarn remain substantially parallel to a shank of the hook. The tying entails wrapping the thread around the yarn and hook down to the bend of the hook, and securing the threaded yarn in place by dabbing the threaded shank with adhesive. Additional tufts are then added and secured as desired, as well as a circular collar with the fly head in the middle. The fly is then trimmed and is ready for fishing.

### BACKGROUND OF THE INVENTION

1. Field of the Invention

The present invention relates to tying flies used in fly fishing and, more particularly, to simplified, comprehensive methods for constructing flies exclusively from wool and the wool flies so tied. These methods comprise a system of using natural wool fibers in place of more traditional or eclectic materials.

2. Description of the Background

Fly fishing is one of the oldest traditional forms of fishing, and recent publicity in film, literature and advertising has sparked a renaissance in fly fishing.

The goal of fly casting is to deliver a substantially weightless fly to a pinpoint target, using line weight for momentum. The fly fisher uses a quick rhythmic back-and-forth flicking motion, using forearm and wrist, with the tip of the fly rod pivoting from vertical to horizontal. The skill necessary to cast well is a combination of touch, eye-hand coordination, and timing. It is considered by many to be an art.

While some may argue whether fly fishing requires artistic talent, none would argue that fly tying requires artistic interpretation and skill. Fly tying has evolved from its earliest known origins circa 200 A.D. to date, where modem flies are often prized for their aesthetic and artistic characteristics. Currently, there are many varieties of flies, inclusive of the following:

Dry flies are flies that float. Most dry flies imitate adult insects that are emerging (breaking out of their nymphal shuck), or are “duns” drying their wings so they can fly away to mate, or returning to the water to lay eggs. Dry flies may also be constructed in such a manner to resemble terrestrial insects such as beetles, grasshoppers, caterpillars and ants.

Wet flies are flies that don't float. They may imitate nymphs and pupae that are emerging, swimming toward the surface of the water, or trying to break through the surface film to become adults.

Nymphs represent the nymphal or larval stage in an insect's life cycle. Wet flies may also be constructed (or tied) to resemble small, darting minnows or other aquatic creatures such as tadpoles, frogs, leeches, worms, hellgrammites, etc., all of which are fed upon by game fish.

The methods and materials used for tying the foregoing and other fly patterns have evolved within the twin constraints of tradition and convention. Some of the earliest known flies were simple wool bodies with colored-feather hackle, body, tail or wings. Claudius Aelian, a Roman, wrote about fly fishing over seventeen centuries ago: “They fasten red wool around a hook and fix to the wool two feathers that grow under a cock's wattles, and which in color are like wax. The fish, attracted by its color and excited, draws close and . . . opens its mouth, but is caught by the hook, and bitter indeed is the feast it enjoys, inasmuch as it is captured.” While today's use of artificial flies is conceptually identical to what Claudius described, the materials and methods for tying them have often grown increasingly complex. Tyers use a variety of exotic game animal hair, fur, or plumage derived from deer, black bear, elk, polar bear, otter, squirrel, fox, skunk, rabbit, partridge, pheasant, mole, seal, beaver, moose, wolverine, jungle cock, turkey, ostrich, goose, duck, muskrat, peacock, and game roosters and hens bred especially for their feathers, and other game animals. In sum, the current fly-tyer's methodology depends heavily on feathers and furs from game animals, and fly construction reflects the philosophy of their use with little or no evidence to substantiate effectiveness. Of course, the method of fly tying varies largely depending on the materials used.

Are feathers and fur necessary, or are they primarily custom? In the long history of fishing flies, why have fly fishermen moved toward the use of materials derived from game animals? The present inventor has addressed these questions. A natural material that is not fully utilized today in the construction of fishing flies is wool. There have been no known efforts to utilize wool exclusively as the primary fly tying material to construct fly tails, bodies, wings, or legs as required by particular wet and dry fly patterns. Hence no effective methods of tying exclusively wool flies to imitate the variety of insect and aquatic life forms attractive to game fish have been developed, even though wool in its several forms is readily available at reasonable cost and is extremely effective. The present inventor has studied the fly-tying attributes of wool fiber and has found a method by which wool can be tied into flies possessing many characteristics attractive to fish. Wool flies fished either as dry flies (on the surface or “top” of the water) or as wet flies (subsurface imitations) mimic many kinds of natural food for game fish, from flies imitating flying insects, to flies imitating terrestrial insects or mammals (mice), to flies (“streamers”) imitating small fish, crayfish, immature crabs, frogs, tadpoles, worms, shrimp, leeches or fish eggs. The flexible nature of wool fiber makes it appealing in fly fishing because of its qualities of texture, flotation, color range, resiliency, strength and durability.

Wool is also environmentally friendly. Wool fleece is harvested by wool growers without harm to the sheep, unlike conventional fly tying materials, which are harvested primarily from specially-raised and sacrificed chickens, or from game animals such as deer, black bear, fox, rabbit, duck, turkey, elk, polar bear, elk, etc. Moreover, wool is an organic material that does not harm the environment and dissipates naturally when exposed to the elements, unlike some plastic or synthetic yarns or other materials that pose a threat to fish and animals if lost or snagged. In addition, wool in its various forms is a “forgiving” material for the fly tyer, which means that it can be shaped, stretched or molded to conform to many patterns.

In light of the above-described benefits, it would be greatly advantageous to provide a method of tying various flies using exclusively wool, as well as the resulting wool flies so tied.

### SUMMARY OF THE INVENTION

It is, therefore, an object of the present invention to provide a method of tying flies comprising a “platform” approach using all-wool rather than traditional materials, in order to create an entirely different class of wool flies that works exceptionally well for trout, bass and other freshwater species as well as in saltwater fly fishing. Such a platform supports the many uses of wool in a fly tying system, based on natural, virgin wool fleece, to create wool flies attractive to game fish. It is based on the innovation of using wool in its various forms (i.e., raw “grease” wool; yarns; washed wool or roving) as the predominant, sole material (excepting (1) a metal fishing hook on which to tie the fly and (2) thread to secure the wool to the metal hook) employed in the manufacture or tying of artificial flies. Artificial fly fishing flies fashioned from wool fleece employing innovative construction techniques elicit “strikes” or bites from game fish such as freshwater trout, salmon, bass, pike, perch, pan fish, carp, etc, and saltwater species such as striped bass, bluefish, sea trout, etc.

It is another object to provide all-wool fly-tying patterns that are easier to tie and offer short-cuts from complicated, conventional fly patterns to simpler ones, without sacrificing the effectiveness of the flies but rather enhancing fly fishing objectives.

It is another object to provide wool fly-tying patterns that are scalable, easily adaptable for larger or smaller-size hooks for tying flies of various sizes, using the same, basic architecture and method.

It is another object to provide the basic wool material for this platform in compact space, due to the compression that can be achieved. Because wool has no “memory” it can be compressed significantly without any changes to its basic structure, making it ideal for the traveling fly tyer or fisherman.

It is another object to utilize the natural qualities and “bugginess” of wool in place of dubbing, thus eliminating time-consuming complexities in fly tying construction.

It is another object to provide an array of all-wool flies that are more economical, environmentally friendly, and effective.

In accordance with the foregoing objects, the present invention is a method of tying a generic all-wool fly, the techniques of which may be adapted to many patterns of fly, using wool as the primary material. Variations of this generic wool fly pattern can be used to create all-wool (wool only) flies—dry flies, streamers, terrestrial flies, or nymphs—of virtually any size, color or design. The method, as applied to a wool dry fly, comprises the core steps of:
(1) obtaining a palette of different wool staples or tufts varying in (a) fiber diameter (coarseness) representing a variety of sheep species; (b) processed form of wool (i.e., raw or “grease” wool; staple; or roving); and (c) coloration; and (d) length;
(2) pulling a tuft of white or light-colored wool (“visibility post”) between the thumb and index finger of each hand to create a slender, smooth, continuous, strong yarn of several inches, suiting the size of the hook;
(3) securing said visibility post with thread onto the hook shank leaving space for a collar and fly head;
(4) twisting a second tuft of chosen color and thickness between the thumb and index finger of each hand to create a yarn that is cut in half to make opposing tuft sections containing roughly equal amounts of fiber;
(5) using a figure-eight wrap to secure parallel tuft sections on opposing sides of the hook, both back (tail) and front (eye), with the visibility post held securely between the tuft sections;
(6) securing opposing tuft sections to form a “collar” perpendicular to the hook shank just below the eye of the hook, extending the wrap to form a head, followed by a knot and whip finish;
(7) trimming the collar, visibility post and tail, with scissors.

Note that the wool fibers are attached parallel to the fishing hook. This allows the all-wool fly to float in the water, and yet to freely release its water load when the fly is cast into the air.

An alternative method eliminates cutting in half the twisted second tuft of wool to make opposing tuft sections containing roughly equal amounts of fiber, and instead divides a single tuft into two sections, this alternative method comprising the steps of:
(1) obtaining a palette of different wool staples or tufts varying in (a) fiber diameter (coarseness) representing a variety of sheep species; (b) processed form of wool (i.e., raw or “grease” wool; staple; or roving); and (c) coloration; and (d) length;
(2) making a single piece of wool tuft;
(3) securing the wool tuft to the hook shank at the bend of the hook;
(4) dividing wool tuft (that will form the fly body) into two equal sections;
(5) pulling a tuft of white or light-colored wool (“visibility post”) between the thumb and index finger of each hand to create a slender, smooth, continuous, strong yarn of several inches, suiting the size of the hook;
(6) securing said visibility post with thread onto the hook shank approximately halfway between the hook shank between the hook bend and the front (eye) of the hook;
(7) securing the divided wool tuft with thread at the division to form a “collar” perpendicular to the hook shank just below the eye; and
(8) knotting the thread to hold the divided wool tuft securely to the hook shank.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1 is a compilation of the steps involved in the method of tying flies using wool, according to the present invention.

FIG. 2 is a perspective view of the proper manner of securing a twisted wool tuft to a hook using a figure-eight wrap.

FIG. 3 is a side view of an alternative pattern for tying a wool nymph fly.

FIG. 4 illustrates a variation in which additional twisted tufts are added and supported by wires that are anchored to the hook for stability, thereby creating suspended legs, wings, or offshoots.

FIG. 5 illustrates a variety of all-wool flies tied in accordance with the method of the present invention.

### DETAILED DESCRIPTION OF THE PREFERRED EMBODIMENTS

Due to its physical structure and its natural chemical make up, the inherent qualities of wool set it apart from traditional fly-making materials from game animals and birds. Many of these beneficial qualities have yet to be explored by the fly fishing industry. For example, a wool fiber can be bent approximately 20,000 times without breaking, and wool lasts for years without losing its resilience. Wool has no inherent “memory,” which means that it can be compressed and stored in containers without becoming kinked, warped, congealed, or otherwise changed in nature. In addition, wool can absorb a great deal of moisture and yet dries completely in a matter of seconds if the fly is constructed following the inventions' prescription. Indeed, wool absorbs and releases moisture in a manner superior to conventional materials (feathers, fur, and synthetic fibers) because these materials tend to lose their loft as they become damp, whereas wool does not become “soggy” as long as the body fibers are attached parallel to the hook shank. Such qualities serve well in fly fishing.

The unique qualities of wool require the fly tyer to depart from traditional fly tying assumptions and methods. Wool has a springy, naturally resilient structure that contains an abundance of air. Wool is light, hence the flies made from wool are extremely light, and this allows the fly fisher to cast flies that drift lightly to the surface of the water. In addition, large wool flies may be constructed that can be presented by the fly fisher using a lighter weight rod, and such flies constructed of only wool allow the fly fisher to cast farther.

Another unique property of wool fibers is their crenelated structure. The crenelations on each fiber hold silicone flotation dressings extremely well, enhancing the natural buoyancy of the wool dry fly.

Wool fiber crenelations also result in a “stickiness” that can be utilized by the fly tyer. Different wool fibers, varying in color or length, may be combined successfully to create flies of uniform quality. This stickiness is important to the fly fisherman because the wool fibers hold together when the fly travels through the air. When such a fly lands on the water (dry fly) or is fished beneath the surface of the water (wet fly, nymph or streamer), the wool fibers compress into a life-like form attractive to game fish. In addition, all-wool fly patterns may be tied through a greater range of hook sizes than conventional materials. These sizes range from 2/0 or larger, down to tiny hooks size 30 or smaller.

The advantages are worth pursuing, and hence a new method of tying wool flies according to the present invention is described below.

Starting Materials

The method of the present invention begins with an array of wool. The tyer accumulates a “palette” of different types of wool. The palette of wool will vary in three respects: 1) coarseness of fibers from various species of sheep; 2) processed form; 3) coloration.

a.) Species of Sheep. Sheep do not produce fibers of a single, uniform diameter. Rather, each animal produces wool of a diameter and texture unique to that individual. However, different species of sheep generally produce predictable fibers within common parameters. For instance, fibers from the Border Leicester, Lincoln, and Romney tend to be of larger diameter (coarse), whereas smaller diameter wool fibers (fine) are more characteristic of the Merino or Debouilet. Tibetan Highland sheep provide long staples of wool having high tensile strength and natural resilience. New Zealand sheep wool offers more bulk. Other wools from some domesticated animals such as llama, alpaca, camel or goat may also supplement sheep's wool in the construction of all-wool flies.

b). Wool is sold in various processed forms, and the present method is based on the practice of using wool in its various forms including raw “grease” wool; yarns; washed wool; or roving (sometimes known as roping) and is the exclusive material in the manufacture or tying of artificial all-wool flies. Preferably, the tyer's palette of different types of wool includes the following:

Raw Wool

Raw or “grease” wool comes straight from the sheep with no washing or processing. The wool with its natural lanolin feels “greasy” to the touch and the fibers shed water well, making it exceptional for dry flies. Grease wool is generally not dyed. Raw, grease wool may contain minute bits of vegetable matter including tiny pieces of sticks, seeds, bits of leaf, etc., and these should be removed by tweezers at the fly-tying bench.

The color of grease wool reflects the color of the sheep from which it comes, ranging from a natural white, cream or ivory, to brown, gray or black. Close examination of grease wool will reveal a spectrum of natural colors often similar to the colors of the insects fly tyers seek to imitate. Unlike dyed wool that creates a uniform coloration throughout, grease wool allows the tyer to pick and choose colors to suit specific needs. A dozen dry flies, for example, from the same lot of grease wool, display subtle variations not unlike the small shades of differences found among populations of hatching mayflies.

Staple

Long, uniform fibers of grease wool are termed a “staple.” Staple length varies from three to five or six inches, depending on the species of sheep, the time of year the sheep was shorn, and other factors. The staple is the length of the fiber when the sheep is sheared. Individual fibers comprising the staple are identical in length, a characteristic that makes the “tuft” or short hand-made “yarn” exceptionally strong and durable. Shades of color vary across the length of the staple, with the wool closest to the sheep having a slightly different hue from the end exposed to the sun and elements.

Roving

Despite the homespun satisfaction found in tying with grease wool, probably the most versatile form of wool for the tyer is known as “roving” or “roping.” Roving is wool that's been washed (removing much of the natural lanolin), carded (metal bristles turn on a rotating drum to align the fibers), combed and dyed. Large machines process the wool into a soft “rope” that a spinner fashions into yarn. Two or three-inch tufts of wool pulled from roving are surprisingly strong.

Yarn

Commercially produced yarn is available in an infinite variety of sizes and shades. Wound yarn fly bodies aren't ideal for the dry fly because the yarn tends to hold water when wound tightly around the shank of the hook. Yarn does make a versatile fly body suitable for nymphs or terrestrials. Tough, single ply yarn completely eliminates the need for dubbing, which may be a difficult and time-consuming process, especially for the novice fly tyer.

Coloration

Natural coloration of wool varies from sheep to sheep. Moreover, shades of color vary across the length of the staple and this variability aids in achieving attractive lures for sport fly fishing. In addition, roving is usually dyed (excepting for natural white or ivory) and is consistent in color and strength. The wool fly tyer will want to accumulate roving of white, black, brown, yellow, red, green and ivory, and shades in between. Other colors of roving such as purple, teal, burgundy and orange, are appropriate attractors for bass, streamers and salt-water flies, and may also be used to add highlights to traditional wool fly patterns. The tyer accumulates his or her palette of wool that varies as described above, and a full complement of conventional fly-tying tools including a bobbin to hold the thread and a vise or hook-holder to secure the hook. Roving or grease wool can be purchased at weaving supply stores or farm shows. One skilled in the art will appreciate that other wools from domesticated animals such as lama, alpaca, camel, or goat may also supplement sheep's wool in the construction of all-wool flies. By adhering to the following tying method the tyer can fashion flies from wool fleece that are attractive to all game fish (e.g., freshwater trout, bass, pike, perch, pan fish, carp, etc.; and saltwater species such as striped bass, bluefish, sea trout, etc.) when used in fly fishing.

Floating characteristics are outstanding because of residual lanolin in the wool and the hard, water-resistant exterior surface of wool fiber, but care must be taken to affix the wool correctly to the metal hook. Wool dry flies constructed in accordance with the following method and dressed with silicon and silicone flotation will “pop up” to the surface of the water when submerged momentarily in a riffle or in fast water, or when retrieved quickly by the fly fisher.

The All-Wool Fly-Tying Method

The method of the present invention is herein described in the context of making an all-wool dry fly, a generic pattern that can be adapted to suit dozens of different flies, from Adams to Quill Gordon. The materials needed, in addition to the tyer's palette and tools as described above, include the following:
Hook: dry fly, #12 to #20 (or smaller)
Thread: 6/0 or 8/0
Tail, body, collar: grease wool or roving

Given the foregoing, tying time is approximately three to four minutes. The all-wool dry fly comprises a tail, body and collar made out of one or two tufts of wool. More complicated patterns (e.g., a “royal coachman,” “hopper,” etc.) may require tying several wool “tufts” into the design. Thus, the method begins by making a twisted tuft. The method progresses as follows:

1^{st}: Selecting the wool

The tyer uses the above-described palette of different wool staples or tufts varying in (a) fiber diameter (coarseness) representing a variety of sheep species; (b) processed form of wool (i.e., raw or “grease” wool; staple; or roving); and (c) coloration; and (d) length.

Choose grease wool or roving in the desired colors (e.g., white, brown, black, gray, etc.) for the tail, body and collar. It is important to sample the strength of the wool by pulling out a tuft and holding it between thumb and index finger of each hand. A tuft is a piece of fiber pulled (not cut) from a larger sample of roving or grease wool. Pull the fibers apart, then successively re-align them. Repeat until the aligned fibers are too strong to pull apart easily and they form a strong yarn between the fingers. Twist the yarn between thumbs and index fingers and inspect for color, texture, strength, and diameter. If the yarn is satisfactory the method proceeds. Tail, body and collar are constructed from a single twisted tuft.

2^{nd}: Twisting the Tufts

Given a suitable tuft, the tyer next twists the tuft between the thumb and index finger of each hand. Twisting the wool tuft creates a yarn several inches long and makes it more manageable to work. A small tuft yields a fine yet strong yarn hardly thicker than a spider thread, a larger tuft makes a heavier yarn the diameter of a pencil. The larger the tuft, the thicker the yarn; the thicker the yarn, the larger the hook. For a tiny #24 hook, use a very small tuft. A larger #14 hook needs proportionally more material. With a little practice the tyer will be able to judge the right size tuft to dress the hook selected. A twisted tuft yarn can be virtually any diameter, from just a few fibers for a #24 dry fly to a 2/0 saltwater fly using a tuft the size of your finger. The more fibers used, the bushier the fly. Wool yarn fibers are tied parallel to the hook shank in the dry fly pattern. This improves floatability as the fibers will not “hold” water but release it when the fly fisher makes a back cast, allowing the fly to dry before it drifts again to the surface of the water.

3rd. Creating a Visibility Post

The wool visibility post stands slightly above the rest of the fly to help the fly-fisherman see-the fly. The post should be comprised of a light color for improved visibility. The secured end of the post on the shank of the hook helps to imitate the slight bulge of the thorax of an insect.

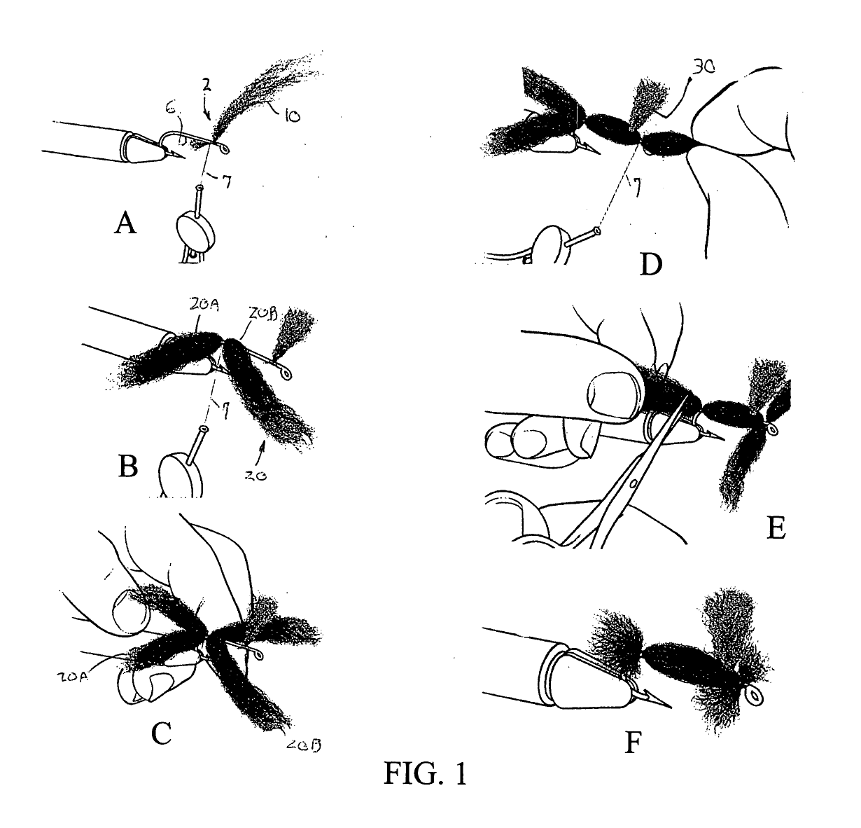

FIG. 1 at position A illustrates creation of a post 2 that entails tying the twisted tuft 10 of white or high-visibility wool to the hook shank 6 as shown. The tuft 10 is positioned along the hook shank 6 leaving space on the shank 6 for a collar and fly head. The tyer secures the twisted tuft post 2 to the shank with thread 7 just behind where the collar will sit as shown in FIG. 1(A), leaving space for a collar and fly head. Excess wool is wrapped around the shank of the hook to add body to the fly and/or create the impression of a thorax. The tyer wraps the thread 7, working it down to the bend of the hook. The tuft will “relax” once it is fully secured to the hook. Dab the threaded shank with adhesive—head cement or clear nail polish.

4^{th}: Tying in Additional Tufts

The tyer repeats the second step above to form a 3-4 inch twisted tuft 20 of chosen color and thickness between the thumb and index finger, and this is cut in half. This provides opposing tuft sections 20A & 20B containing equal amounts of fiber. One tuft section 20B is tied in on one side of the hook shank as shown in FIG. 1(B) and the other half 20A on the other side. The twisted tuft sections 20A & 20B will form an “X” with the center of the X on top at the bend of the hook, as seen in FIG. 1(C). The tyer uses a figure-eight wrap to secure the parallel tuft sections 20A & 20B on opposing sides of the hook, both back (tail) and front (head/eye), with the visibility post held securely between the tuft sections. Leave trimming until later.

5^{th}: Segmented or Unsegmented Body

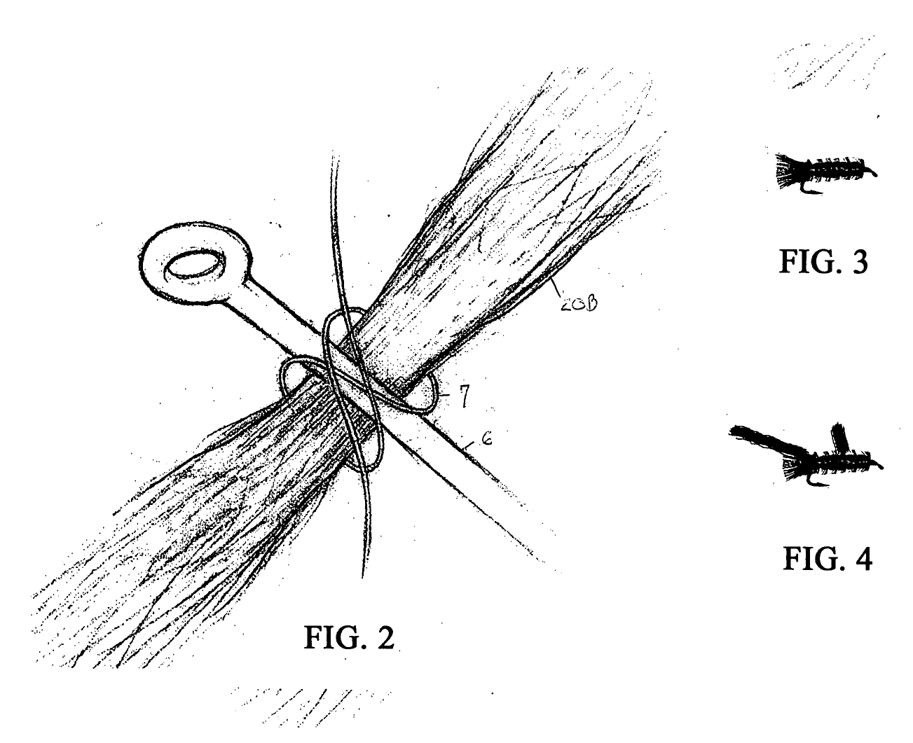

At this point the bobbin is directly below the bend of the hook. The tyer works the thread to hang just beneath the post. The tyer pulls the fibers of the two twisted tufts (forming the leading edge of the X) to stretch the tufts on both sides of the hook shank 6 and secures the perpendicular post and the tufts 20A & 20B on each side of the hook shank 6. Then taking each tuft in hand, the tyer bends them back to expose the eye, strokes the tufts to point downward or upward as desired, secures them with thread using a figure-eight wrap, and winds the thread head as seen in FIG. 2.

6^{th}: Collar

A collar helps to create a realistic silhouette of an insect. It also helps the dry fly to float high on the surface of the water. The fibers in the collar provide many points of contact to the surface of the water and aids in supporting the weight of the fly. Referring back to FIG. 1(E), the collar 30 may be fashioned from the same twisted tufts that begin at the tail, form the body along the hook shank and end just below the head. The opposing tuft sections 20A & 20B are secured to form the “collar” perpendicular to the shank just below the eye of the fly, extending the wrap to form a head, followed by a knot and whip finish. The tyer can shape the wool to form a crescent-shaped collar beneath the head for an emerger or dun, or tease it to stick out at right angles (as shown at FIG. 1(E)) to imitate a “spinner,” which is an insect that has mated and fallen onto the surface of the water. The post may serve to fill in the collar on the topside of the shank.

Another technique to achieve a collar 30 is to tie off the wool body just below the head, pull a fresh tuft, twist, wrap a figure-eight to secure it from the bottom of the shank. That takes care of the underside. Pull another tuft and repeat the process of securing it on top of the shank. The result will be a circular collar with the fly head in the middle. This method is particularly good if you want to add color or highlights that are not already in the fly body. Again, tie the tufts 20A & 20B in first and trim after all else is done so that the tied-in wool doesn't get in your way.

7th: Trimming

Trimming is best left until last, after the whip finish and the application of fly cement, inasmuch as the different parts of the fly can be adjusted more readily while they're longer. Tufts can be positioned to be out of the way while the tyer is working on other parts of the fly. Trim the collar (by grasping both tufts downward or perpendicular to the shank as desired), post and tail, using a high-quality pair of scissors. Remove the fly from the vise, fluff the wool fibers with your fingers and trim to cull stray fibers and adjust proportions. The fly is now ready for use. Inspect the fly often on the stream. Trim errant fibers periodically if they get shaggy.

8^{th}: Variations

The above-described method can be varied slightly to eliminate cutting in half the twisted second tuft 20 of wool in the fourth step above, by dividing the twisted tuft 20 to make opposing tuft sections 20A & 20B containing roughly equal amounts of fiber, this alternative method comprising the steps of:
(1) obtaining a palette of different wool staples or tufts varying in (a) fiber diameter (coarseness) representing a variety of sheep species; (b) processed form of wool (i.e., raw or “grease” wool; staple; or roving); and (c) coloration; and (d) length;
(2) making a single piece of wool tuft 10;
(3) securing the wool tuft 10 to the hook shank 6 at the bend of the hook;
(4) dividing wool tuft 20 (that will form the fly body) into two equal sections 20A & 20B;
(5) pulling a second tuft of white or light-colored wool (“visibility post”) between the thumb and index finger of each (as above) hand to create a slender, smooth, continuous, strong yarn of several inches, suiting the size of the hook;
(6) securing said visibility post with thread onto the hook shank approximately halfway between the hook shank between the hook bend and the front (eye) of the hook;
(7) securing the divided wool tuft with thread at the division to form a “collar” perpendicular to the hook shank just below the eye; and
(8) knotting the thread to hold the divided wool tuft securely to the hook shank.

Both of the above-described methods can easily be varied to create a variety of dry flies, wet flies, nymphs, or streamers. For example, to tie an all-wool nymph as shown in FIG. 3. The wooly bugger is a popular “streamer” or “nymph” resembling a caterpillar, leech, hellgrammite, etc. The fly tying method is as described above, except that after creation of the post a second tuft of wool is tied parallel to the hook shank along its entire length, over the post intermittently using a spaced-spiral tie as shown. This creates a long undulating body down to the bend of the hook, where the post juts outward, having become visible in the tail.

In each of the foregoing methods, other materials can be added as desired, including hair, feathers, string, chenille, rubber filaments or tubes, strips of reflective foil, manmade fibers, glitter, or other materials, in order to create special effects. However, these do not necessarily add to the effectiveness of the fly. Other techniques include the blending and layering of different colors onto the hook, varying the length of the tail, or adjusting the wool fibers on the body to be pronounced (shaggy) or subdued (smooth).

Additional tufts can be added to create legs, wings or antennae of varying shapes and forms, depending on the insect or aquatic creature the fly is fashioned to imitate.

Moreover, as seen in FIG. 4, additional twisted tufts can be added and supported by wires anchored to the hook for stability, thereby creating suspended legs, wings, or offshoots. In this case the tufts are inserted over the wire as shown to embed the wires therein, and then the tufts are secured by thread to the hook. An alternative way to create suspended legs, wings, or offshoots is to wax the twisted tuft appendage to make the wool fibers adhere tightly together.

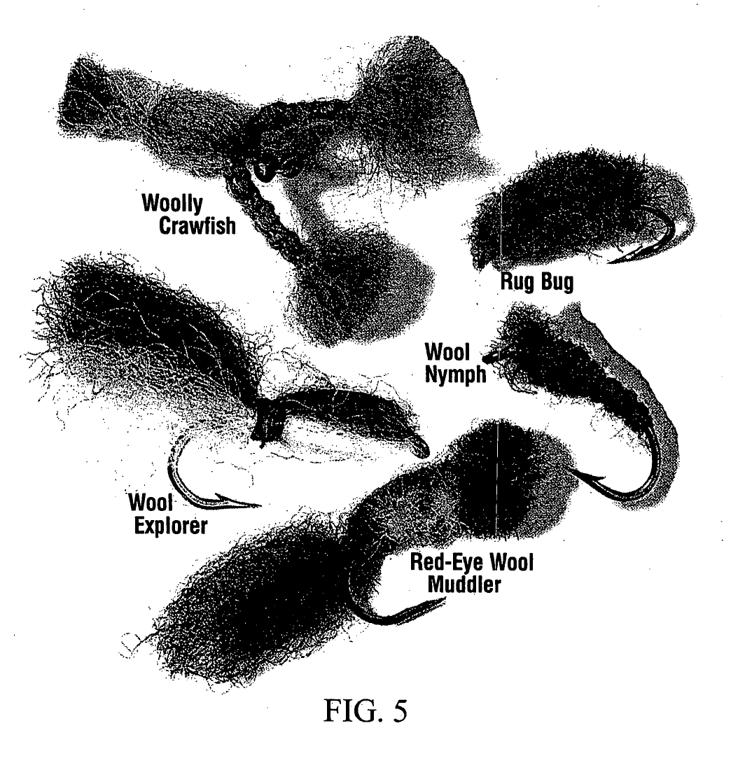

FIG. 5 illustrates a variety of all-wool flies tied in accordance with the method of the present invention, inclusive of a Woolly Crawfish, Rug Bug, Wool Nymph, Red-Eye Wool Muddler, Wool Explorer (clockwise from top). Virtually any type of fly can be created using the above-described basic procedure to achieve any variation or desired effect, including streamers, nymphs, and terrestrial patterns as well. Aerodynamics and hydrodynamics can be altered as desired by varying the density of the tufts of wool, and weight can be added to fish wool flies beneath the surface of the water. In addition, glitter, Mylar flash, ornamental threads and even beading can be incorporated for effect at the discretion of the tyer, but are not required to achieve success. In all such cases the basic method of tying flies using wool rather than traditional materials creates a new platform on which to create a different class of flies that work exceptionally for trout, bass and other freshwater species as well as saltwater species.

The all-wool fly-tying patterns are scalable and easily adaptable for larger or smaller-size hooks for tying flies of various sizes. In all such cases the all-wool fly-tying patterns are generally easier to tie, and the resulting wool flies are far more economical and environmentally friendly than traditional flies.

Having now fully set forth a detailed example and certain modifications incorporating the concept underlying the present invention, various other modifications will obviously occur to those skilled in the art upon becoming familiar with said underlying concept. It is to be understood, therefore, that within the scope of the appended claims, the invention may be practiced otherwise than as specifically set forth in the appended claims.

1. A method of tying an effective fly using wool as a primary material, comprising the steps of:
obtaining a palette of different wool staples varying in species of sheep, processed form and coloration;
extracting a tuft of wool from one of said staples;
twisting a first tuft between the thumb and index finger of each hand to create a yarn;
positioning the twisted yarn along a hook leaving space on the hook for a collar and fly head;
creating a post on said hook by tying the twisted yarn to the hook with thread, while ensuring that the fibers of yarn remain parallel to a shank of said hook, and wrapping thread and yarn around the shank of the hook to imitate a thorax;
continuing to wrap thread around the yarn and hook down to the bend of the hook;
securing the threaded yarn in place by dabbing the threaded shank with adhesive.
twisting a second tuft between the thumb and index finger of each hand to create a yarn, and cutting said yarn in half to create opposing tuft sections containing equal amounts of fiber;
tying one of said tuft sections on one side of the hook, and tying the other of said tuft sections on the other side of the hook;
stretching the opposing tuft sections on both sides of the hook and securing them with the thread using a figure-eight wrap;
tying a circular collar with the fly head in the middle; and
trimming the collar and post with scissors.

2. The method of claim 1, wherein said step of obtaining a palette of different wool staples comprises obtaining a variety of different wool staples or tufts varying in fiber diameter representing a variety of sheep species, different processed form including raw or grease wool, staple and roving, and different coloration and length.

3. The method of claim 1, further comprising a step of tying a wool visibility post to the shank of said hook, said visibility post comprising a light color wool for improved visibility.

4. The method of claim 3, wherein a secured end of the visibility post on the shank of the hook also imitates a slight bulge of the thorax of an insect.

5. The method of claim 1, further comprising a step of tying in at least one additional tuft of wool to create any one from among a group including legs, wings or antennae of varying shapes and forms.

6. The method of claim 1, wherein said step of positioning the twisted yarn along said hook wool comprises positioning with wool fibers attached parallel to the hook to allows the wool fly to float in the water and yet to freely release its water load when cast into the air.

7. A method of tying an effective fly using wool as a primary material, comprising the steps of:
obtaining a palette of different wool staples varying in species of sheep, processed form and coloration;
extracting a tuft of wool from one of said staples;
twisting a first tuft between the thumb and index finger of each hand to create a yarn;
positioning the twisted yarn along a hook leaving space on the hook for a collar and fly head;
creating a post on said hook by tying the twisted yarn to the hook with thread, while ensuring that the fibers of yarn remain parallel to the shank of said hook, and wrapping thread and yarn around the shank of the hook to imitate a thorax;
continuing to wrap thread around the yarn and hook down to the bend of the hook;
securing the threaded yarn in place by dabbing the threaded shank with adhesive.
twisting a second tuft between the thumb and index finger of each hand to create a yarn, and dividing said second tuft of yarn in half to create opposing tuft sections containing equal amounts of fiber;
tying said second twisted tuft onto the hook using thread between said opposing tuft sections, and knotting the thread to hold the divided wool tuft securely to the hook
tying a circular collar with the fly head in the middle;
trimming the collar and post with scissors.

8. The method of claim 7, wherein said step of obtaining a palette of different wool staples comprises obtaining a variety of different wool staples or tufts varying in fiber diameter representing a variety of sheep species, different processed form including raw or grease wool, staple and roving, and different coloration and length.

9. The method of claim 7, further comprising a step of tying a wool visibility post to a shank of said hook, said visibility post comprising a light color wool for improved visibility.

10. The method of claim 9, wherein a secured end of the visibility post on a shank of said hook also imitates a slight bulge of the thorax of an insect.

11. The method of claim 7, further comprising a step of tying in at least one additional tuft of wool to create any one from among a group including legs, wings or antennae of varying shapes and forms.

12. The method of claim 7, wherein said step of positioning the second twisted tuft along said hook wool comprises positioning with wool fibers attached parallel to the hook to allows the wool fly to float in the water and yet to freely release its water load when cast into the air.
